(19) United States
(12) Patent Application Publication
(10) Pub. No.: US 2005/0242647 A1
(43) Pub. Date: Nov. 3, 2005

(54) Device for reclining seatback of vehicle

(76) Inventor: Hyeong Jun Kim, Anyang (KR)

Correspondence Address: MORGAN, LEWIS & BOCKIUS LLP (SF), 2 PALO ALTO SQUARE, PALO ALTO, CA, 94306, US

(21) Appl. No.: 11/010,805

(22) Filed: Dec. 13, 2004

(30) Foreign Application Priority Data
Apr. 16, 2004 (KR) 2004-0026115

(51) Int. Cl. B60N 2/20

(52) U.S. Cl. 297/354.12; 297/374; 297/376

(57) ABSTRACT

The device for reclining a seatback of a vehicle has an inclination angle of a seatback that is adjusted at many steps in such a manner that a reclining device with a low price and simple structure is inwardly installed in a seatback of a vehicle. The device for reclining a seatback of a vehicle, includes a folding lever that is tiltably engaged to an end of the seatback. A locker has a plurality of fixing holes formed at regular intervals and a slot by which the lower ends of the fixing holes communicate with each other. The device also includes a rod of which one end is connected to one surface of the folding lever, and the other end is connected with one surface of the locker. A striker is engaged in a vehicle body panel and is selectively inserted into the fixing holes along a slot of the locker. The device further includes an elastic member of which one end is fixed to an inner frame of the seatback, and the other end is fixed to the locker for providing a recovery force to its original position in a state that the locker is upwardly pulled.

### CROSS-REFERENCE TO RELATED APPLICATIONS

This application claims priority of Korean Application No. 10-2004-0026115, filed on Apr. 16, 2004, the disclosure of which is incorporated fully herein by reference.

### FIELD OF THE INVENTION

The present invention relates to a device for reclining a seatback of a vehicle, and in particular to a device for reclining a seatback of a vehicle in which an inclination angle of a seatback is adjusted at many steps in such a manner that a reclining device with a low price and simple structure is inwardly installed in a seatback of a vehicle.

### BACKGROUND OF THE INVENTION

Conventionally, a reclining device of a vehicle is directed to a device capable of adjusting an inclination angle of a seatback and is connected between a seatback and a seat cushion. In the case of a SUV (Sports Utility Vehicle), the reclining device has a high fabrication cost and is fabricated with a weight of about 3 kg for a strength in compliance with various rules adapted to a fabrication of seat.

Currently, a reclining device of a seatback is adapted only to SUVs and luxurious vehicles. As the demand of customers has been increased for the use of a reclining device of a seatback. Similar seats are required in smaller sized and lightweight vehicles. However, the reclining device used in SUVs have a high fabrication cost and weight. Therefore, there are many problems in adapting the reclining device to a small sized vehicle or a lightweight vehicle.

### SUMMARY OF THE INVENTION

Embodiments of the present invention provide a device for reclining a seatback of a vehicle that addresses the problems encountered in the conventional art.

The present invention provides a device for reclining a seatback with a simple structure and a low fabrication cost. The reclining device is installed in a seatback and can be adjusted at many steps wherein a locker having a fixing groove with a striker inserted therein may be moved up and down by using a lever.

More particularly, there is provided a device for reclining a seatback of a vehicle, comprising a folding lever that is tiltably engaged to an end of the seatback. A locker is provided that has a plurality of fixing holes formed at regular intervals and a slot by which the lower ends of the fixing holes communicate with each other. A receiver is provided in an inner frame of the seatback in which the locker may be mounted. A rod is provided of which one end is connected to one surface of the folding lever, and the other end is connected with one surface of the locker. A striker is engaged in a vehicle body panel and is selectively inserted into the fixing holes along a slot of the locker. An elastic member is provided of which one end is fixed to an inner frame of the seatback, and the other end is fixed to the locker for thereby providing a recovery force to its original position when the locker is upwardly pulled. A spring is connected between the inner frame and the rod for thereby controlling an operational gap when the rod moves up and down.

### BRIEF DESCRIPTION OF THE DRAWINGS

The aforementioned aspects and other features of the present invention will be explained in the following description, taken in conjunction with the accompanying drawings, wherein:

FIG. 1 is a front view illustrating a device for reclining a seatback of a vehicle according to the present invention;

FIG. 2 is a perspective view illustrating a device for reclining a seatback of a vehicle according to the present invention;

FIG. 3A and 3B are schematic views illustrating a state that an inclination of a seatback is adjusted at three steps in a device for reclining a seatback of a vehicle according to the present invention;

FIG. 4 is a perspective view illustrating a device for reclining a seatback of a vehicle according to the present invention wherein the view shows a striker; and

### DETAILED DESCRIPTION OF PREFERRED EMBODIMENTS

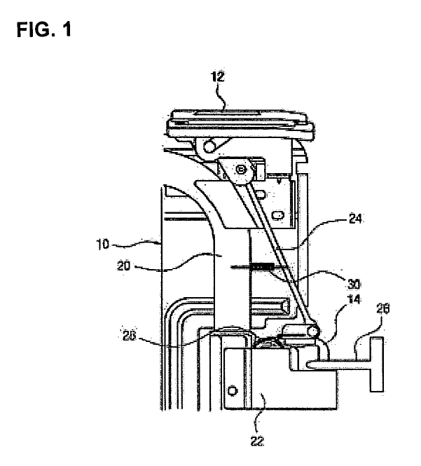

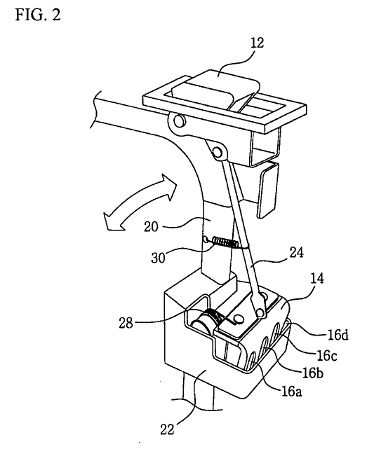

The embodiments of the present invention will be described with reference to the accompanying drawings. FIG. 1 is a front view illustrating a device for reclining a seatback of a vehicle according to the present invention, and FIG. 2 is a perspective view illustrating a device for reclining a seatback of a vehicle according to the present invention.

The present invention is basically directed to a reclining device adapted to a seatback of a vehicle, wherein the reclining device has a simple construction and a low fabrication cost. The reclining device of the present invention is installed within a seatback. The detailed construction will be described.

A casing, of which upper and lower sides pass through, is engaged on an upper surface of the seatback 10. A folding lever 12 is tiltably hinged to the casing. There is provided a locker 14 cooperating with a tilting operation of the folding lever 12. A plurality of fixing holes (16a, 16b, 16c and 16d in the Figures herein) are formed in one surface of the locker 14 at regular intervals in a longitudinal direction of a vehicle. A longitudinal slot 18 is formed in the lower end of the fixing holes 16a, 16b, 16c and 16d. The fixing holes 16a, 16b, 16c and 16d, communicate with each other by the slot 18 provided in the lower side of the same.

The locker 14 may be mounted in a concave receiver 22 provided in an inner frame of the seatback 10 and moves up and down based on a tilting operation of the folding lever 12.

A rod 24 is integrally connected between the lower surface of the folding lever 12 and the upper surface of the locker 14 for an up and down movement of the locker 14. A channel bar shaped striker 26 is integrally engaged in a portion of a panel corresponding to an outer lateral surface of the seatback 10, and is selectively inserted into the fixing holes 16a, 16b, 16c and 16d along the slot 18 of the locker 14.

One end of a return spring 28 is fixed to the inner frame 20 of the seatback, and the other end of the same is fixed to the locker 14 for thereby providing a recovery force to the original position (the mounted position in the receiver) when the locker 14 is upwardly pulled. A spring 30 is integrally connected between the inner frame 20 and the rod 24 wherein the spring 30 controls an operational gap when the rod 24 moves up or down. The operation of the device for reclining a seatback of a vehicle according to the present invention will be described.

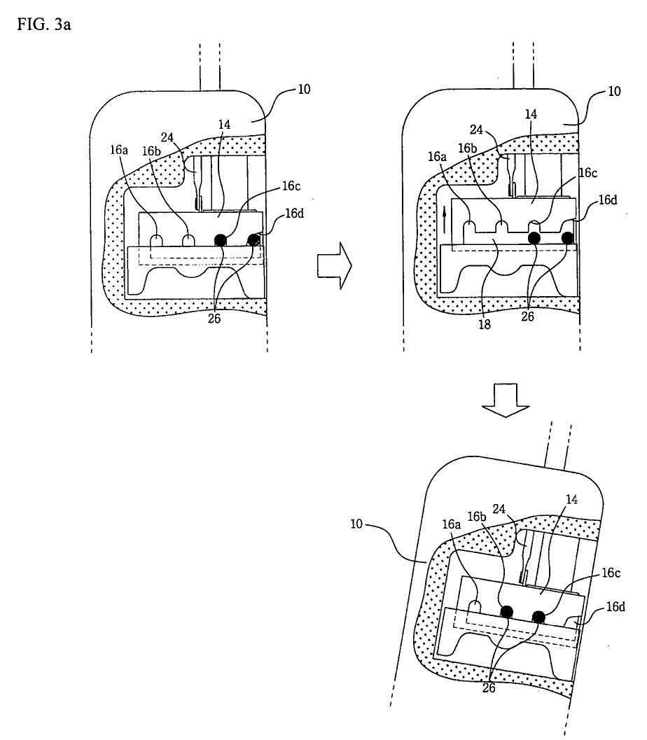

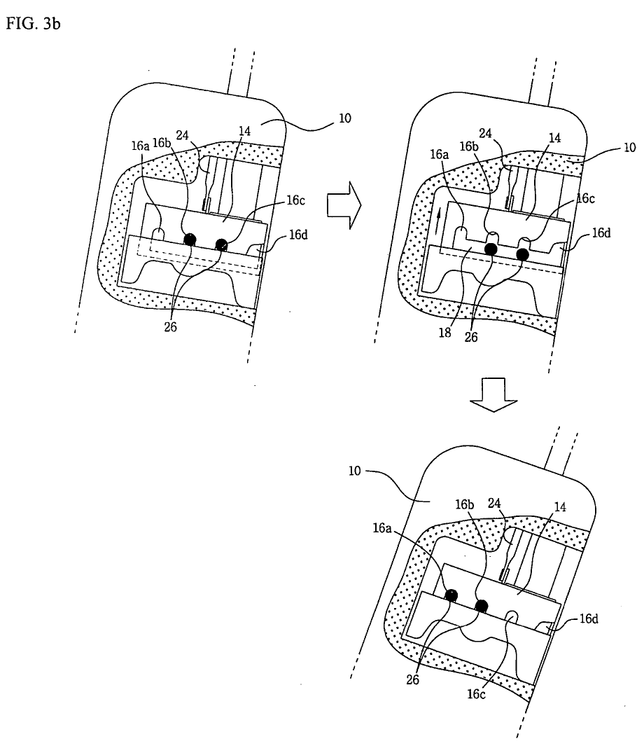

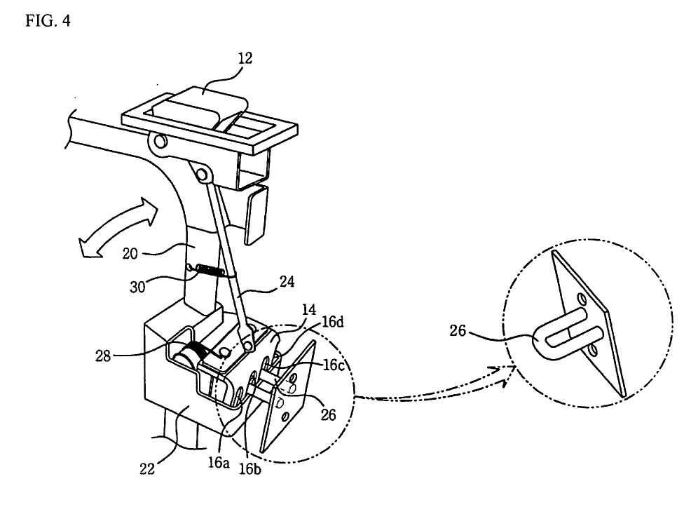

FIG. 3A and 3B are schematic views illustrating a state that an inclination of a seatback is adjusted at three steps in a device for reclining a seatback of a vehicle according to the present invention. As shown in FIG. 3A, in case that the inclination angle of the seatback 10 is adjusted to the first step, the striker 26 is inserted into two fixing holes 16c and 16d provided in the rear most portion of the locker 14.

When the folding lever 12 is tilted, the rod 24 is moved up and the locker 14 is moved up by the rod 24. Then, the striker 26 fixed to the vehicle body at one end is moved to the position of the slot 18. In the above state, when the user pushes the seatback 10 backward, as shown in FIG. 3A, the striker 26 is moved to the positions of the fixing holes 16b and 16c along the slot 18. When the folding lever (in the tilted state) is released, the locker 14 is mounted in the interior of the concave receiver 22 by a recovery force of the return spring 28, and at the same time the striker 26 is inserted into two fixing holes 16b and 16c provided at the intermediate portion. In this manner, the seatback 10 is fixed at the second step inclination angle, and the seatback 10 is further declined. The third step inclination angle state of the reclining device for a seatback of a vehicle according to the present invention will be described with reference to FIG. 3B.

Likewise, in order to adjust the seatback 10 from the second step inclination position to the third step inclination position, as shown in FIG. 3B, the folding lever 12 should be tilted first. Then, the rod 24 moves up, and the locker 14 is moved up by the rod 24. The position of the striker 26 is moved to the position of the slot 18 from the fixing holes 16b and 16c.

When the user pushes further the seatback 10 backwardly, the striker 26 is moved to the positions of the fixing holes 16a and 16b along the slot 18. In this state, when the folding lever is released, the locker 14 is mounted into the interior of the receiver 22 by a recovery force of the return spring 28. The striker 26 is inserted into two fixing holes 16a and 16b positioned in the front side in four fixing holes 16a, 16b, 16c and 16d, so that the seatback 10 gets the third step inclination state. Therefore, in the present invention, it is possible to easily adapt a low-priced and simple-structured reclining device to a seatback of a vehicle.

As described above, in the device for reclining a seatback of a vehicle according to the present invention, it is possible to easily adjust an inclination angle of a seatback based on a simple construction and low cost by providing a striker fixed to a vehicle body and a locker having fixing holes into which the striker is inserted

1. A device for reclining a seatback of a vehicle, the device comprising:
a folding lever that is tiltably engaged to an end of the seatback;
a locker that has a plurality of fixing holes formed at regular intervals and a slot by which the lower ends of the fixing holes communicate with each other;
a rod, one end of which is connected to one surface of the folding lever, and the other end is connected with one surface of the locker;
a striker that is coupled to a vehicle body panel, wherein said striker is configured to selectively insert into the fixing holes after moving along the slot of the locker; and
an elastic member of which one end is fixed to an inner frame of the seatback, and the other end is fixed to the locker for providing a recovery force to an original position when the locker is upwardly pulled.

2. The device of claim 1, wherein a spring is connected between the inner frame and the rod for thereby controlling an operational gap when the rod moves up and down.

3. The device of claim 1, further comprising a receiver that is fixed to the inner frame of the seatback so that the locker is mounted therein.

4. The device of claim 1, wherein the elastic member is a return spring.

5. The device of claim 1, wherein the folding lever is engaged to an upper side of the seatback.

6. The device of claim 1, wherein the rod is hinged to an upper side of the locker.
